(19) United States
(12) Patent Application Publication
(10) Pub. No.: US 2024/0123792 A1
(43) Pub. Date: Apr. 18, 2024

(54) VEHICLE TANK AND METHOD FOR MANUFACTURING VEHICLE TANK

(71) Applicant: TOYODA GOSEI CO., LTD., Kiyosu-shi (JP)

(72) Inventors: Kazutoshi MIYAKE, Kiyosu-shi (JP); Kenichiro KANEKO, Kiyosu-shi (JP)

(21) Appl. No.: 18/480,652

(22) Filed: Oct. 4, 2023

(30) Foreign Application Priority Data
Oct. 18, 2022 (JP) 2022-166578

(51) Int. Cl. B60H 1/00

(52) U.S. Cl. CPC B60H 1/00499; B60H 1/00592; B60H 1/00278

(57) ABSTRACT

Provided is a vehicle tank provided in a temperature control system configured to control a temperature of a temperature control target installed in a vehicle by using a temperature control liquid. The vehicle tank includes a container having a bottomed cylindrical shape including an open end opening upward and storing the temperature control liquid, a lid portion fixed to the open end and covering an opening of the open end, the lid portion including a refill port for refilling the container with the temperature control liquid from the outside, a heat storage layer made of a heat storage material and surrounding the container, and a heat insulation layer made of a heat insulation material and surrounding the container outside of the heat storage layer. A pump for sending the temperature control liquid in the container to a flow path and a temperature control unit configured to control the temperature of the temperature control liquid flowing through the flow path are fixed to the lid portion.

### CROSS-REFERENCE TO RELATED APPLICATIONS

This application claims priority based on Japanese Patent Application No. 2022-166578 filed on Oct. 18, 2022, the entire disclosure of which is incorporated herein by reference.

### BACKGROUND

### Field

The present disclosure relates to a vehicle tank and a method for manufacturing the vehicle tank.

### Related Art

Relating to a vehicle tank provided in a temperature control system for a vehicle, JP 2010-229841 A discloses a heat-retaining structure that is disposed in a flow path of engine cooling water in a vehicle. In this heat-retaining structure, liquid stored in a container of the heat-retaining structure is kept warm by a heat storage material layer disposed around the outer periphery of the container and an anti-convection layer disposed on an outer side of the heat storage material layer.

Vehicle temperature control systems that take up less space have been desired in recent years. Such a temperature control system includes various components for controlling the temperature of a liquid used for temperature control and supplying the liquid to a temperature control target. In a configuration in which these components are arranged far from each other in the temperature control system, a larger installation space may be required for the temperature control system, and JP 2009-229841 A makes no special consideration for the arrangement of such components.

### SUMMARY

The present disclosure may be implemented in the form of the following aspects.

According to a first aspect of the present disclosure, there is provided a vehicle tank provided in a temperature control system configured to control a temperature of a temperature control target installed in a vehicle by using a temperature control liquid. The vehicle tank includes a container portion having a bottomed cylindrical shape and including an open end opening upward and storing the temperature control liquid, a lid portion fixed to the open end and covering an opening of the open end, the lid portion including a refill port for refilling the container portion with the temperature control liquid from the outside, a heat storage layer made of a heat storage material and surrounding the container portion, and a heat insulation layer made of a heat insulation material and surrounding the container portion outside of the heat storage layer. A pump for sending the temperature control liquid in the container portion to a flow path and a temperature control unit configured to control the temperature of the temperature control liquid flowing through the flow path are fixed to the lid portion.

According to a second aspect of the present disclosure, there is provided a method for manufacturing a vehicle tank provided in a temperature control system configured to control a temperature of a temperature control target installed in a vehicle by using a temperature control liquid. The method for manufacturing a vehicle tank includes preparing a first tank having a bottomed cylindrical shape and including a first open end and storing the temperature control liquid, a second tank having a bottomed cylindrical shape and including a second open end and being surrounded by a heat insulation layer including a heat insulation material, and a lid member including a refill port for refilling the first tank with the temperature control liquid, fixing the first open end and the second open end to the lid member such that the first tank is housed in the second tank with a space present between the first tank and the second tank and an opening of the first open end and an opening of the second open end are covered by the lid member, filling the space with a heat storage material that is configured to store heat by using latent heat and is liquefied by being heated to a temperature greater than or equal to its melting point from an inlet formed in the lid member, thereby surrounding the first tank with the heat storage material, after the filling step, plugging the inlet, and fixing a pump for sending the temperature control liquid in the first tank to the outside and a temperature control unit configured to control the temperature of the temperature control liquid flowing through a flow path in communication with the pump.

### BRIEF DESCRIPTION OF THE DRAWINGS

FIG. 1 is a diagram illustrating a schematic configuration of a temperature control system according to a first embodiment.

FIG. 2 is a perspective view illustrating a schematic configuration of a tank according to the first embodiment.

FIG. 3 illustrates a cross section taken along line III-III in FIG. 2.

FIG. 4 is a process diagram of a method for manufacturing the tank.

FIG. 5 is a perspective view illustrating how the tank is manufactured.

FIG. 6 is a cross-sectional view illustrating how the tank is manufactured.

FIG. 7 is a first table showing results of a comparative test.

FIG. 8 is a second table showing results of the comparative test.

### DETAILED DESCRIPTION

### A. First Embodiment

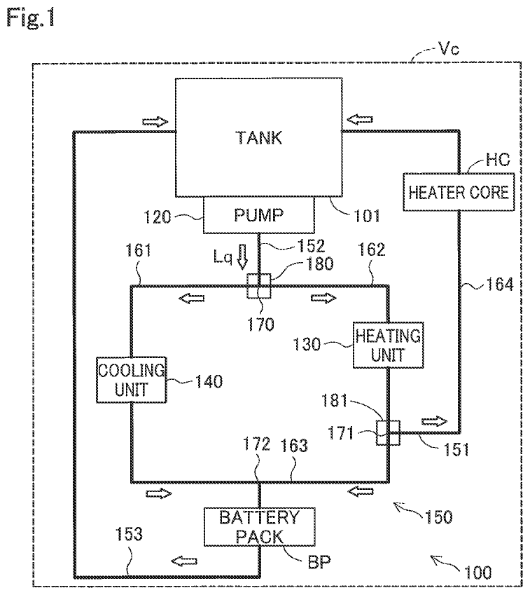

FIG. 1 is a diagram illustrating a schematic configuration of a temperature control system 100 according to a first embodiment. The temperature control system 100 is installed in a vehicle Vc and controls the temperature of a temperature control target by using a temperature control liquid Lq. The temperature control target is installed in the vehicle Vc. The temperature control liquid Lq refers to a liquid that is used to control the temperature of the temperature control target. The temperature control liquid Lq may also be referred to as a coolant.

In the present embodiment, the vehicle Vc is configured as a battery electric vehicle (BEV) that is driven by a drive battery. The temperature control target in the present embodiment corresponds to a battery pack BP including the drive battery configured as a lithium-ion battery and a heater core HC for heating provided in a heating, ventilation, and air-conditioning (HVAC) system of the vehicle Vc. In other embodiments, the vehicle Vc may be, for example, a gasoline or diesel vehicle, a hybrid electric vehicle (HEV), a plug-in hybrid electric vehicle (PHEV), or a fuel cell vehicle (FCV). Additionally, in other embodiments, the temperature control target is not particularly limited and may be, for example, a battery configured as a lead battery, or an engine, a motor, an inverter, or a control computer installed in the vehicle Vc.

The temperature control system 100 according to the present embodiment includes a tank 101 and a circulation circuit 150. The circulation circuit 150 includes a flow path 151 through which the temperature control liquid Lq flows and is configured such that the temperature control liquid Lq can circulate between the tank 101 and the temperature control target. The flow path 151 is formed of, for example, a rubber hose or other piping member. In FIG. 1, the flow of the temperature control liquid Lq in the circulation circuit 150 is denoted schematically by white arrows. In the following description, the tank 101 may also be referred to as a vehicle tank or reserve tank.

The circulation circuit 150 includes a pump 120, a heating unit 130, a cooling unit 140, a first valve 180, and a second valve 181. Each of these components is connected to the piping member that forms the flow path 151. A control computer provided in the vehicle Vc, for example, controls the drive of each of these components. Further, in the present embodiment, the pump 120, the heating unit 130, and the first valve 180 are disposed in the tank 101. This configuration will be described below.

In the present embodiment, a first flow path 152 of the flow path 151 is connected to a downstream side of the pump 120 and branches into a first branch flow path 161 and a second branch flow path 162 at a first branch point 170. The second branch flow path 162 further branches into a third branch flow path 163 and a fourth branch flow path 164 at a second branch point 171. The first branch flow path 161 and the third branch flow path 163 merge at a merge point 172. A portion of the flow path 151 downstream of the merge point 172 may also be referred to as a second flow path 153.

The cooling unit 140 is disposed in the first branch flow path 161 to cool the temperature control liquid Lq flowing through the first branch flow path 161. The cooling unit 140 is, for example, a radiator or a chiller. The heating unit 130 is disposed in the second branch flow path 162 to heat the temperature control liquid Lq flowing through the second branch flow path 162. The heating unit 130 is, for example, a heater or a heat exchanger. The heating unit 130 and the cooling unit 140 each function as a temperature control unit that controls the temperature of the temperature control liquid Lq flowing through the flow path 151.

The first valve 180 is disposed at the first branch point 170. The first valve 180 is configured as an electrically operated switching valve, for example. The first valve 180 switches between three states: a state in which only the first branch flow path 161 is open, a state in which only the second branch flow path 162 is open, and a state in which both the first branch flow path 161 and the second branch flow path 162 are open. The second valve 181 is configured as an electrically operated switching valve, similar to the first valve 180, for example. The second valve 181 switches between a state in which only the third branch flow path 163 is open, a state in which only the fourth branch flow path 164 is open, and a state in which both the third branch flow path 163 and the fourth branch flow path 164 are open. Hereinafter, valves that open and close the flow path 151, such as the first valve 180 and the second valve 181, may also be referred to simply as “valves”.

In the circulation circuit 150, when the first branch flow path 161 is open, the temperature control liquid Lq cooled by the cooling unit 140 can be supplied to the battery pack BP, whereby the battery pack BP can be cooled. When the second branch flow path 162 and the third branch flow path 163 are open, the temperature control liquid Lq heated by the heating unit 130 can be supplied to the battery pack BP, whereby the battery pack BP can be heated. Additionally, when the second branch flow path 162 and the fourth branch flow path 164 are open, the temperature control liquid Lq heated by the heating unit 130 can be supplied to the heater core HC, whereby the heater core HC can be heated. Thus, in the circulation circuit 150, the temperatures of the battery pack BP and the heater core HC, which are the temperature control targets, can be controlled by using the temperature control liquid Lq.

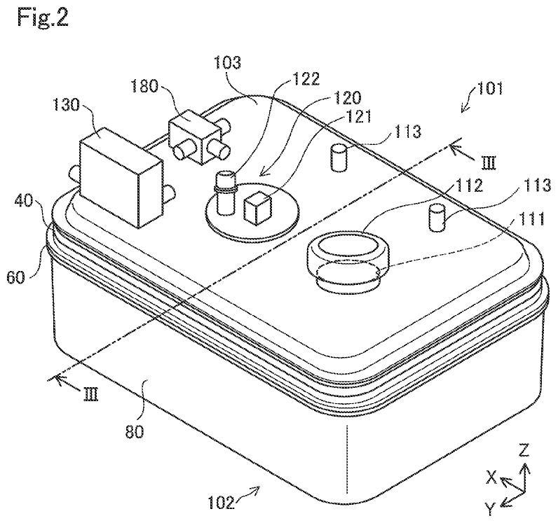

FIG. 2 is a perspective view illustrating a schematic configuration of the tank 101 according to the first embodiment. FIG. 2 includes arrows denoting mutually orthogonal X, Y, and Z directions. The X, Y, Z directions are directions along three mutually orthogonal spatial axes being the X, Y, Z axes, and include a direction along the X, Y, and Z axis and an opposite direction along the X, Y, and Z axis, respectively. The X and Y axes are axes along the horizontal plane and the Z axis is an axis along the vertical direction. Arrows denoting the X, Y, and Z directions are also used in other drawings as appropriate. The X, Y, and Z directions in FIG. 2 and the X, Y, and Z directions in other drawings denote the same directions. In the following description, the +Z direction may also be referred to as “up” and the −Z direction may also be referred to as “down”.

As illustrated in FIG. 2, the tank 101 includes a lower portion 102 and a lid portion 103. The lid portion 103 may also be referred to as an “upper section”.

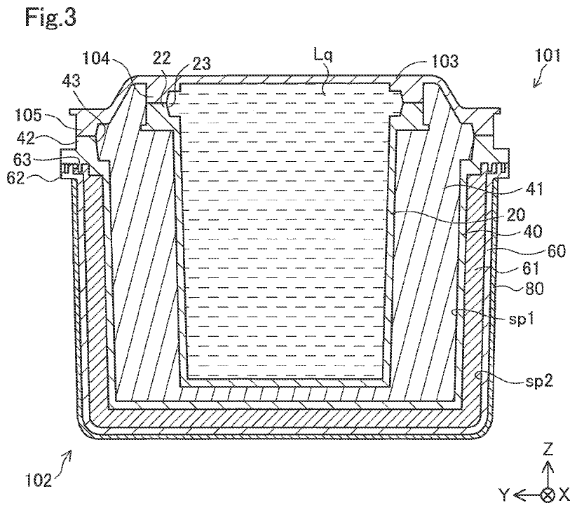

FIG. 3 illustrates a cross section taken along line III-III in FIG. 2. As illustrated in FIG. 3, the lower portion 102 includes a first tank 20, a heat storing layer 41, and a heat insulation layer 61. In the present embodiment, the lower portion 102 also includes a heat shield layer 80.

The first tank 20 is configured as a container that stores the temperature control liquid Lq. The first tank 20 has a bottomed cylindrical shape and has a first open end 22 that is open facing upward. In the present embodiment, the first tank 20 has a substantially rectangular external shape. The first open end 22 has a flange shape. The first tank 20 is made of, for example, polypropylene (PP) or glass fiber reinforced polypropylene (GFPP). Hereinafter, the first tank 20 may also be referred to as a “container portion”. The opening of the first open end 22 may also be referred to as a “first opening 23”. In addition, the first open end 22 may also be referred to simply as an “open end”.

The heat storage layer 41 is formed of a heat storage material and surrounds the first tank 20. In the present specification, the phrase “surrounds the first tank 20” refers to surrounding the bottom and side surfaces of the first tank 20 from the outside. In the present embodiment, the heat storage layer 41 is formed of a latent heat storage material and uses latent heat generated when the latent heat storage material undergoes a phase change at its melting point to keep the temperature control liquid Lq in the first tank 20 warm. More specifically, the heat storage layer 41 in the present embodiment is made of paraffin wax and is formed between the first tank 20 and the second tank 40. The paraffin wax is prepared such that its melting point is between 50° C. and 60° C., for example. Paraffin wax is a wax-like solid at temperatures below its melting point, a liquid at temperatures above its melting point, and a mixture of a solid and a liquid at its melting point.

The heat insulation layer 61 is formed of a heat insulation material and surrounds the first tank 20 outside of the heat storage layer 41. The heat insulation material of the heat insulation layer 61 insulates the temperature control liquid Lq stored in the first tank 20 from the outside. In the present embodiment, the heat insulation layer 61 is made of a polyethylene foam and is formed between the second tank 40 and the third tank 60.

The second tank 40 has a bottomed cylindrical shape and has a second open end 42 that is open facing upward. In the present embodiment, the second tank 40 has a substantially rectangular outer shape. The second open end 42 has a flange shape. An opening of the second open end 42 may also be referred to as a “second opening 43”. The second opening 43 has an opening area in the X and Y directions that is larger than an opening area of the first opening 23 in the X and Y directions. The second tank 40 is made of, for example, PP or GFPP, similar to the first tank 20.

The first tank 20 described above is housed in the second tank 40 with a gap between the bottom of the first tank 20 and the bottom of the second tank 40 and a gap between side walls of the first tank 20 and side walls of the second tank 40. This arrangement creates a space sp1 between the first tank 20 and the second tank 40. In the present embodiment, this space sp1 is filled with paraffin wax serving as the heat storage material, whereby the heat storage layer 41 is formed.

The third tank 60 has a bottomed cylindrical shape and has a third open end 62 that is open facing upward. In the present embodiment, the third tank 60 has a substantially rectangular outer shape. The third open end 62 has a flange shape. The third open end 62 and the second open end 42 described above are formed such that a top side of the third open end 62 and a bottom side of the second open end 42 interlock together. An opening of the third open end 62 may also be referred to as a “third opening 63”. The third opening 63 has an opening area in the X and Y directions that is larger than an opening area of the first opening 23 in the X and Y directions. The third tank 60 is made of, for example, PP or GFPP, similar to the first tank 20.

The second tank 40 described above is housed in the third tank 60 with a gap between the bottom of the second tank 40 and the bottom of the third tank 60 and a gap between side walls of the second tank 40 and side walls of the third tank 60, with the bottom side of the second open end 42 interlocked with the top side of the third open end 62. This arrangement creates a space sp2 between the second tank 40 and the third tank 60. In the present embodiment, polyethylene foam serving as a heat insulation material is disposed in this space sp2, whereby the heat insulation layer 61 is formed.

The heat shield layer 80 is formed of a heat shield material and is disposed on an outer side of the heat insulation layer 61. In the present embodiment, the heat shield layer 80 is made of aluminum. More specifically, the heat shield layer 80 is formed of an aluminum film deposited on the outer sides of the bottom and side walls of the third tank 60. In other embodiments, the heat shield layer 80 may be formed of, for example, an aluminum foil applied to the outer sides of the bottom and side walls of the third tank 60. The heat shield layer 80 suppresses heat radiation from inside the tank 101 to outside the tank 101 by reflecting heat radiation generated by the temperature control liquid Lq in the first tank 20 into the tank 101. The heat shield material may also be referred to as a reflective material or a heat-reflecting material.

The lid portion 103 is fixed to the first open end 22 and covers the first opening 23. In the present embodiment, the lid portion 103 is also fixed to the second open end 42 and covers the second opening 43. The lid portion 103 is made of, for example, PP or GFPP, similar to the first tank 20. In the present embodiment, the lid portion 103 has a substantially flat plate shape. A first protrusion 104 and a second protrusion 105 that protrude downward are provided at positions of the lid portion 103 corresponding to the first open end 22 and the second open end 42 in the X and Y directions, respectively. A lower portion of the first protrusion 104 and an upper portion of the first open end 22, as well as a lower portion of the second protrusion 105 and an upper portion of the second open end 42 are welded together by, for example, hot plate welding, vibration welding, or laser welding. With this configuration, the lid portion 103 is fixed to the upper sides of the first tank 20 and the second tank 40, covering the first opening 23 and the second opening 43. The space between the first tank 20 and the lid portion 103, also between the second tank 40 and the lid portion 103 is preferably sealed in a liquid-tight manner.

As illustrated in FIG. 2, the lid portion 103 includes a refill port 111 and a port 113. The refill port 111 is an opening used for refilling the first tank 20 with the temperature control liquid Lq from the outside. In the present embodiment, the refill port 111 includes a removable cap 112 that seals the refill port 111. The port 113 has an opening used for collecting the temperature control liquid Lq supplied to the temperature control target in the tank 101 via the flow path 151. In the present embodiment, the lid portion 103 includes two ports 113. One of the ports 113 is connected to a piping member forming the second flow path 153 illustrated in FIG. 1, and the other of the ports 113 is connected to a piping member forming the fourth branch flow path 164. The refill port 111 and the ports 113 are formed in the lid portion 103 at positions overlapping the first opening 23 when viewed along the vertical direction.

As illustrated in FIG. 2, the pump 120 and the heating unit 130 described above are fixed to the lid portion 103. In the present embodiment, the first valve 180 described above is also fixed to the lid portion 103.

The pump 120 sends the temperature control liquid Lq in the first tank 20 to the first flow path 152 illustrated in FIG. 1. In the present embodiment, the pump 120 is configured as a centrifugal water pump and is fixed to the lid portion 103, extending through the lid portion 103. In the present embodiment, a discharge port 122 and a connector 121 of the pump 120 are located on the upper side of the lid 103. Wiring components for supplying power to the pump 120 are connected to the connector 121. The discharge port 122 of the pump 120 and an inlet port of the first valve 180 are connected by a piping member that forms the first flow path 152. The pump 120 draws the temperature control liquid Lq into a liquid chamber from a suction port in the pump 120 disposed in the first tank 20 by rotating an impeller disposed in the liquid chamber, and discharges the drawn temperature control liquid Lq from the discharge port 122 to the first flow path 152.

One of two outlet ports of the first valve 180 is connected to an inlet port of the heating unit 130 by a piping member that forms the second branch flow path 162. The temperature control liquid Lq is guided into the heating unit 130 via the inlet port of the heating unit 130. After being guided into the heating unit 130, the temperature control liquid Lq is heated while passing through the heating unit 130 and then discharged from an outlet port of the heating unit 130. A piping member that forms the third branch flow path 163 is connected to the outlet port of the heating unit 130. A piping member that forms the fourth branch flow path 164 is connected to the other outlet port of the first valve 180.

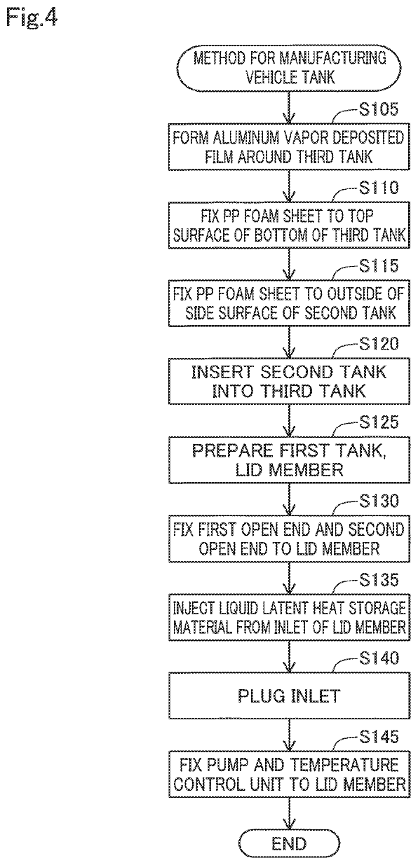

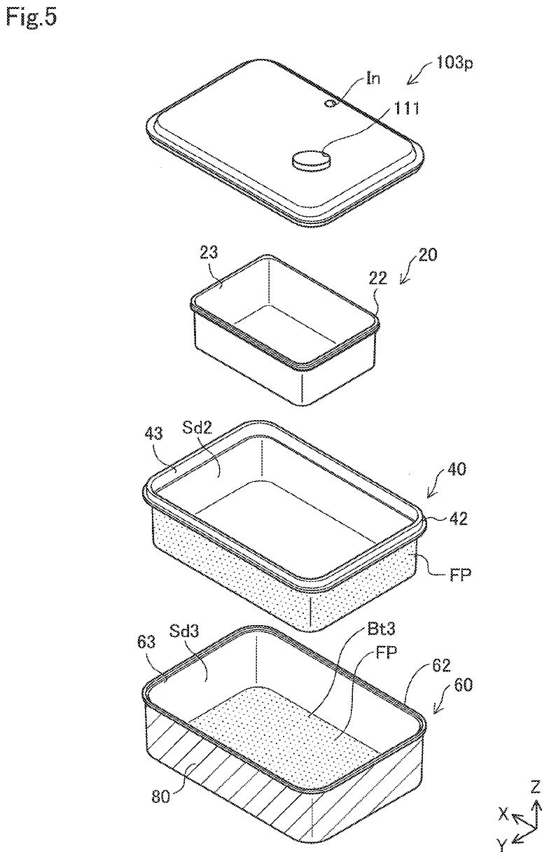

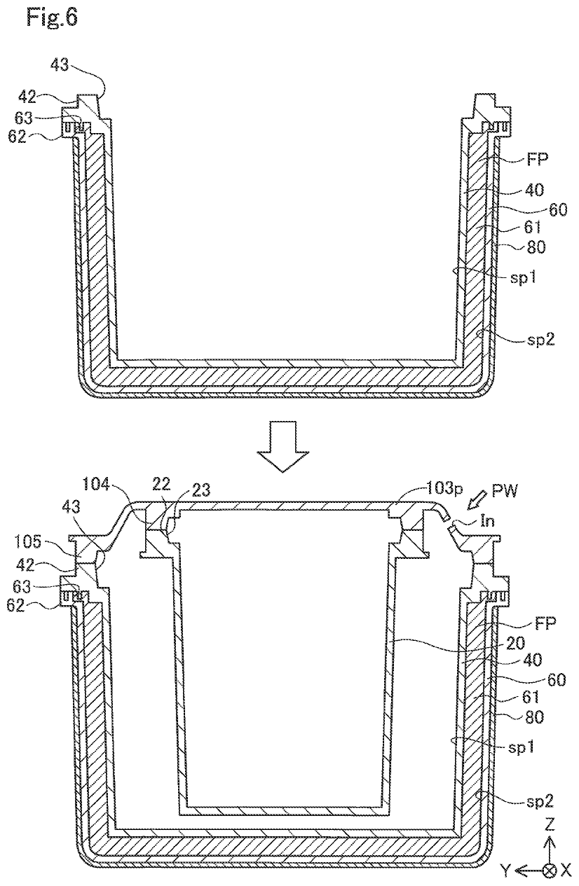

FIG. 4 is a process diagram of a method for manufacturing the tank 101 according to the present embodiment. FIG. 5 is a perspective view illustrating how the tank 101 is manufactured. FIG. 6 is a cross-sectional view illustrating how the tank 101 is manufactured.

In the method for manufacturing the tank 101, first, in step S105, the heat shield layer 80 is formed around the third tank 60. More specifically, in step S105, an aluminum vapor deposited film serving as the heat shield layer 80 is formed on the bottom surface of a bottom Bt3 of the third tank 60 and on the outer side of a side surface Sd3 of the third tank 60. In FIG. 5, the portion where the aluminum vapor-deposited film is formed is denoted by hatching sloping upward to the right. Next, in step S110, a polyethylene foam sheet FP serving as a heat insulation material is fixed to a top surface TS by an adhesive, for example, so as to cover the top surface of the bottom Bt3 of the third tank 60. Next, in step S115, the polyethylene foam sheet FP is fixed to a side surface Sd2 of the second tank 40 by an adhesive, for example, so as to cover the side surface Sd2 from the outside. In FIG. 5, the portion where the polyethylene foam sheet FP is disposed is denoted by dotted hatching.

In step S120, the second tank 40 is inserted into the third tank 60 and the lower side of the second open end 42 and the upper side of the third open end 62 are interlocked together. Thus, as illustrated in the top half of FIG. 6, the second tank 40 surrounded by the heat insulation layer 61 is prepared. Next, in step S125, the first tank 20 and a lid member 103p in which the refill port 111 is formed are prepared. The lid member 103p is a member used for forming the lid portion 103. In the present embodiment, the lid member 103p includes the first protrusion 104 and the second protrusion 105, similar to the lid portion 103. The process of preparing the first tank 20, the second tank 40 surrounded by the heat insulation layer 61, and the lid member 103p including the refill port 111, as in steps S105 to S125, is also referred to as a “first process”.

In step S130, a second process is performed to fix the first open end 22 and the second open end 42 to the lid member 103p. In the second process, as illustrated in the bottom half of FIG. 6, the first tank 20 is housed in the second tank 40 with the space sp1 present between the first tank 20 and the second tank 40, the first opening 23 and the second opening 43 are covered by the lid member 103p, and the first open end 22 and the second open end 42 are fixed to the lid member 103p. More specifically, in step S130, as described above, the lower portion of the first protrusion 104 and the upper portion of the first open end 22, as well as the lower portion of the second protrusion 105 and the upper portion of the second open end 42 are welded together by, for example, hot plate welding.

In step S135, a third process is performed to inject the latent heat storage material, which is liquefied by heating, into the space sp1 from an inlet In formed in the lid member 103p. In the third process according to the present embodiment, a paraffin wax PW having a melting point between 50° C. and 60° C. and serving as the latent heat storage material is liquefied by being heated above its melting point. The liquefied paraffin wax PW is then injected into the space sp1 from the inlet In to fill the space sp1. The injected paraffin wax PW surrounds the first tank 20 and thereby forms the heat storage layer 41, as illustrated in FIG. 3. The inlet In allows the space sp1 to communicate with the outside. The inlet In may be formed in step S135, for example, may be formed in a step prior to step S135, such as in a preparation process, or may be formed in advance. In the present specification, “liquid state” refers to having fluidity in a broad sense and also includes a mixture of a solid and a liquid and a gelatinous state.

In step S140, a fourth process of plugging the inlet In is performed. In step S140, for example, a stopper member that plugs the inlet In is inserted into the inlet In, and then the stopper member and the periphery of the inlet In are bonded to plug the inlet port In in a liquid-tight manner.

In step S145, a fifth process of fixing the pump 120 and the temperature control unit to the lid member 103p is performed. In step S145 according to the present embodiment, the pump 120, the heating unit 130, and the first valve 180 are fixed to the lid member 103p. In step S145, for example, a fixing hole, surface irregularities, or the like that facilitate fixing each of these components may be formed in the lid member 103p before fixing the components. Further, the fixing hole, surface irregularities, or the like may be formed in the lid member 103p prior to step S145.

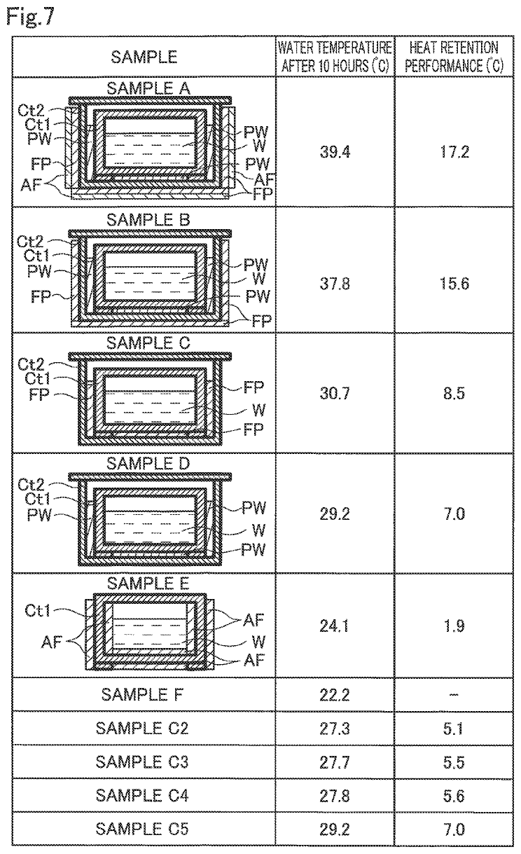

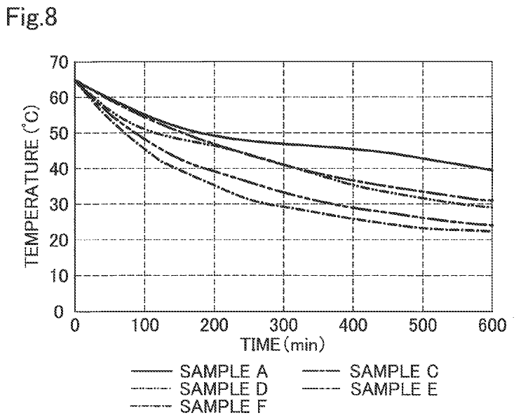

FIG. 7 is a first graph showing results of a comparative test that compares the heat retention performance of different vehicle tanks. FIG. 8 is a second graph showing results of the comparison test.

In the comparison test, a bottomed cylindrical first container Ct1 that has an open top portion, a second container Ct2 that has an open top portion and is larger than the first container Ct1, the polyethylene foam sheet FP, the paraffin wax PW, and an aluminum foil AF serving as a heat shield material were used to prepare each sample.

A Sample A was prepared by applying the polyethylene foam sheet FP around the second container Ct2 and applying the aluminum foil AF to the outside of the polyethylene foam sheet FP, then inserting the first container Ct1 into the second container Ct2 and injecting the paraffin wax PW between the first container Ct1 and the second container Ct2. A Sample B was prepared by applying the polyethylene foam sheet FP around the second container Ct2, then inserting the first container Ct1 into the second container Ct2 and filling the space between the first container Ct1 and the second container Ct2 with the paraffin wax PW. A Sample C was prepared by inserting the first container Ct1 into the second container Ct2 and disposing the polyethylene foam sheet FP between the first container Ct1 and the second container Ct2. A Sample D was prepared by inserting the first container Ct1 into the second container Ct2 and filling the space between the first container Ct1 and the second container Ct2 with the paraffin wax PW. A Sample E was prepared by applying the aluminum foil AF to the inner and outer surfaces of the side walls and the inner and outer surfaces of the bottom of the first container Ct1. The first container Ct1 was used for a Sample F. In each of the samples, the first container Ct1 was fitted with a lid made of PP and that closes the opening of the first container Ct1, and the second container Ct2 was fitted with a lid made of PP and that closes the opening of the second container Ct2.

Samples C2, C3, C4, and C5 were also prepared as samples in which the polyethylene foam sheet FP in Sample C was replaced by another heat insulation material. In sample C2, modified polyphenylene ether (PPE) foam beads (available from Asahi Kasei Corporation) were used as the heat insulation material. In Sample C3, urethane foam (Achilles Board AG, available from Achilles Corporation) was used as the heat insulation material. In Sample C4, a special thin heat insulation material (KR GENEQ SHIELD, available from Kanto Reinetsu Kogyo Co., Ltd.) was used as the heat insulation material. In Sample C5, styrene foam was used as the heat insulation material. The thermal conductivities of each of the heat insulation materials used in Sample C and Samples C2 to C5 were 0.031 W/(m·K), 0.034 W/(m·K), 0.024 W/(m·K), 0.023 W/(m·K) and 0.04 W/(m·K), respectively.

In the comparison test, a change in temperature over time was measured with a thermometer under the conditions of room temperature (23° C.) and with the first container Ct1 of each sample storing 2.5 L of water W, which was 65° C. FIG. 7 shows the water temperature after 10 hours and the heat retention performance for each sample. For each sample, the heat retention performance is expressed as the water temperature after 10 hours relative to the water temperature after 10 hours in Sample F. In other words, a higher temperature value representing the heat retention performance indicates higher heat retention performance for that sample. In the graph of FIG. 8, the vertical axis represents water temperature and the horizontal axis represents time. FIG. 8 shows the results of comparison tests with Samples A, C, D, E and F.

As shown in FIG. 7, the heat retention performance of Sample C was higher than the heat retention performance of Samples C2 to C5. The heat retention performance of Samples A and B was higher than the heat retention performance of Samples C to F. The heat retention performance of Sample A was higher than the heat retention performance of Sample B. In addition, as shown in FIG. 8, Sample A exhibited less decrease in water temperature in all temperature ranges compared to Samples C to F. Thus, it was found that the tank 101 has particularly excellent heat retention performance when the lower portion 102 of the tank 101 includes the heat storage layer 41 made of paraffin wax, the heat insulation layer 61 made of foamed polyethylene, and the heat shield layer 80 made of aluminum.

The tank 101 according to the present embodiment described above includes the heat storage layer 41 surrounding the first tank 20 storing the temperature control liquid Lq, the heat insulation layer 61 surrounding the first tank 20 outside of the heat storage layer 41, and the pump 120 and the heating unit 130 are fixed to the lid portion 103 covering the first opening 23 and including the refill port 111. With this configuration, the pump 120 and heating unit 130 can be fixed to the lid portion 103 instead of to the first tank 20 surrounded by the heat storage layer 41 and the heat insulation layer 61. As a result, since it is not necessary to form fixing holes or surface irregularities in the lower portion 102 for fixing the pump 120 and the heating unit 130, as compared to a configuration in which the pump 120 and the heating unit 130 are fixed to the lower portion 102, for example, the heat retention performance of the heat storage layer 41 and the heat insulation layer 61 is less likely to deteriorate. In addition, since the pump 120 and the heating unit 130 can be aggragated in the tank 101, for example, an increase in the installation space of each component in the horizontal direction and an increase in the installation space due to an increase in piping length can be suppressed. Thus, in the temperature control system 100, increased installation space due to components being arranged far from each other can be suppressed.

In the present embodiment, since the temperature control liquid Lq after heating the battery pack BP and the heater core HC can be collected in the tank 101 and be kept warm in the tank 101, waste heat can be used efficiently in the temperature control system 100. With this configuration, the output of the heating unit 130 can be suppressed and power consumption of the battery for driving of the battery pack BP is more likely to be suppressed.

In the present embodiment, a valve for opening and closing the flow path 151 is further fixed to the lid portion 103. With this configuration, the valve can be further aggregated in the tank 101.

In addition, the present embodiment includes the heat shield layer 80 that surrounds the first tank 20 outside of the heat insulation layer 61. With this configuration, the heat storage layer 41, the heat insulation layer 61, and the heat shield layer 80 can efficiently keep the temperature control liquid Lq in the first tank 20 warm.

In the present embodiment, the heat storage layer 41 is made of paraffin wax, the heat insulation layer 61 is made of a polyethylene foam, and the heat shield layer 80 is made of aluminum. With this configuration, the temperature control liquid Lq in the first tank 20 can be kept warm more efficiently. In addition, the material cost of the tank 101 can be reduced compared to a configuration in which the heat storage layer 41 is made of, for example, microcapsules in which the heat storage material is sealed. Further, the material cost of the tank 101 can be reduced compared to a configuration in which the heat shield layer 80 is made of, for example, silver or gold.

### B. Other Embodiments

(B1) In the above-described embodiment, the heating unit 130 is fixed to the lid portion 103 as the temperature control unit. In the above embodiment, instead of or in addition to the heating unit 130, the cooling unit 140 configured as a chiller, for example, may be fixed to the lid portion 103 as the temperature control unit.
(B2) In the above embodiment, for example, two or more of the pumps 120, two or more of the heating units 130, two or more of the cooling units 140, and two or more valves may be disposed in the lid portion 103.
(B3) In the above embodiment, a switching valve is fixed to the lid portion 103. However, for example, a valve that simply opens and closes one flow path 151 may be fixed to the lid portion 103. Alternatively, no valve may be fixed to the lid portion 103.
(B4) In the above embodiment, the heat shield layer 80 is provided, but the heat shield layer 80 may not be provided. A tank 101 not including the heat shield layer 80 can be manufactured by, for example, omitting step S105 of the method for manufacturing illustrated in FIG. 4. In other words, the method for manufacturing the tank 101 may not include a step of forming the heat shield layer 80.
(B5) In the above embodiment, the heat storage layer 41 is made of paraffin wax, but the heat storage layer 41 may not be made of paraffin wax. For example, the heat storage layer 41 may be made of an alkaline earth metal salt, an alkali metal salt, an alkaline earth metal hydroxide, an alkali metal hydroxide, naphthalene, or melamine or acrylic microcapsules in which the heat storage material is encapsulated. Alternatively, the heat storage layer 41 may be made of, for example, a sensible heat storage material.
(B6) In the above embodiment, the heat insulation layer 61 is made of a polyethylene foam, but the heat insulation layer 61 may not be made of a polyethylene foam. For example, the heat insulation layer 61 may be made of PPE, urethane foam, styrene foam, polyolefin foam, a foamed rubber, or a foamed metal.
(B7) In the above embodiment, the heat shield layer 80 is made of aluminum but may not be made of aluminum. For example, the heat shield layer 80 may be made of gold, silver, or an aluminum alloy.
(B8) In the above embodiment, the fifth step is performed after the fourth step in the method for manufacturing the tank 101, but the fifth step may not be performed after the fourth step. For example, the fifth step may be performed immediately after the first step.

The present disclosure is not limited to the embodiments described above and may be implemented in various configurations within a range not departing from the gist of the present disclosure. For example, the technical features in the embodiments can be replaced or combined as appropriate to solve some or all of the above issues or to achieve some or all of the above effects. Any technical feature not described as essential in the specification may be deleted as appropriate. For example, the present disclosure may be realized in the manner described below.
(1) According to a first aspect of the present disclosure, there is provided a vehicle tank provided in a temperature control system configured to control a temperature of a temperature control target installed in a vehicle by using a temperature control liquid. The vehicle tank includes a container portion having a bottomed cylindrical shape and including an open end opening upward and storing the temperature control liquid, a lid portion fixed to the open end and covering an opening of the open end, the lid portion including a refill port for refilling the container portion with the temperature control liquid from the outside, a heat storage layer made of a heat storage material and surrounding the container portion, and a heat insulation layer made of a heat insulation material and surrounding the container portion outside of the heat storage layer. A pump for sending the temperature control liquid in the container portion to a flow path and a temperature control unit configured to control the temperature of the temperature control liquid flowing through the flow path are fixed to the lid portion.

According to this aspect, since the pump and the temperature control unit are fixed to the lid portion instead of to the container portion surrounded by the heat storage layer and the heat insulation layer, the pump and the temperature control unit can be aggregated in the vehicle tank while ensuring the heat retention performance of the vehicle tank. Accordingly, installation space of the temperature control system can be suppressed.
(2) In the above aspect, a valve configured to open and close the flow path may also be fixed to the lid portion. According to this aspect, the valve can be further aggregated in the vehicle tank.
(3) In the above aspect, the vehicle tank may further include a heat shield layer made of a heat shield material and surrounding the container portion outside of the heat insulation layer. According to this aspect, the temperature control liquid in the container portion can be kept warm efficiently due to the heat storage layer, the heat insulation layer and the heat shield layer.
(4) In the above aspect, the heat storage material may be made of paraffin wax, the heat insulation material may be made of a polyethylene foam, and the heat shield material may be made of aluminum. According to this aspect, the temperature control liquid in the container portion can be kept warm more efficiently.
(5) According to a second aspect of the present disclosure, there is provided a method for manufacturing a vehicle tank provided in a temperature control system configured to control a temperature of a temperature control target installed in a vehicle by using a temperature control liquid. The method for manufacturing a vehicle tank includes preparing a first tank having a bottomed cylindrical shape and including a first open end and storing the temperature control liquid, a second tank having a bottomed cylindrical shape and including a second open end and being surrounded by a heat insulation layer including a heat insulation material, and a lid member including a refill port for refilling the first tank with the temperature control liquid, fixing the first open end and the second open end to the lid member such that the first tank is housed in the second tank with a space present between the first tank and the second tank and an opening of the first open end and an opening of the second open end are covered by the lid member, filling the space with a heat storage material that is configured to store heat by using latent heat and is liquefied by being heated to a temperature greater than or equal to its melting point from an inlet formed in the lid member, thereby surrounding the first tank with the heat storage material, after the filling step, plugging the inlet, and fixing a pump for sending the temperature control liquid in the first tank to the outside and a temperature control unit configured to control the temperature of the temperature control liquid flowing through a flow path in communication with the pump.

The present disclosure may be implemented in the form of various aspects other than the vehicle tank described above, such as a temperature control system or vehicle equipped with the vehicle tank.

What is claimed is:

1. A vehicle tank provided in a temperature control system configured to control a temperature of a temperature control target installed in a vehicle by using a temperature control liquid, the vehicle tank comprising:
a container portion having a bottomed cylindrical shape and including an open end opening upward and storing the temperature control liquid;
a lid portion fixed to the open end and covering an opening of the open end, the lid portion including a refill port for refilling the container portion with the temperature control liquid from the outside;
a heat storage layer made of a heat storage material and surrounding the container portion; and
a heat insulation layer made of a heat insulation material and surrounding the container portion outside of the heat storage layer, wherein
a pump for sending the temperature control liquid in the container portion to a flow path and a temperature control unit configured to control the temperature of the temperature control liquid flowing through the flow path are fixed to the lid portion.

2. The vehicle tank according to claim 1, wherein a valve configured to open and close the flow path is fixed to the lid portion.

3. The vehicle tank according to claim 1, further comprising:
a heat shield layer made of a heat shield material and surrounding the container portion outside of the heat insulation layer.

4. The vehicle tank according to claim 3, wherein
the heat storage layer is made of paraffin wax,
the heat insulation layer is made of a polyethylene foam, and
the heat shield layer is made of aluminum.

5. A method for manufacturing a vehicle tank provided in a temperature control system configured to control a temperature of a temperature control target installed in a vehicle by using a temperature control liquid, the method comprising:
preparing a first tank having a bottomed cylindrical shape and including a first open end and storing the temperature control liquid, a second tank having a bottomed cylindrical shape and including a second open end and being surrounded by a heat insulation layer including a heat insulation material, and a lid member including a refill port for refilling the first tank with the temperature control liquid;
fixing the first open end and the second open end to the lid member such that the first tank is housed in the second tank with a space present between the first tank and the second tank and an opening of the first open end and an opening of the second open end are covered by the lid member;
filling the space with a heat storage material that is configured to store heat by using latent heat and is liquefied by being heated to a temperature greater than or equal to its melting point from an inlet formed in the lid member, thereby surrounding the first tank with the heat storage material;
after the filling step, plugging the inlet; and
fixing a pump for sending the temperature control liquid in the first tank to the outside and a temperature control unit configured to control the temperature of the temperature control liquid flowing through a flow path in communication with the pump.
